(19) United States
(12) Patent Application Publication
(10) Pub. No.: US 2026/0029752 A1
(43) Pub. Date: Jan. 29, 2026

(54) KINEMATIC CHAIN MECHANISM FOR A HOROLOGY MOVEMENT

(71) Applicant: Montres Breguet S.A., L'Abbaye (CH)

(72) Inventor: Jérôme MACE, Le Pont (CH)

(73) Assignee: Montres Breguet S.A., L'Abbaye (CH)

(21) Appl. No.: 19/225,305

(22) Filed: Jun. 2, 2025

(30) Foreign Application Priority Data
Jul. 26, 2024 (EP) 24191178.3

(51) Int. Cl. G04B 13/00

(52) U.S. Cl. CPC G04B 13/00

(57) ABSTRACT

A kinematic chain mechanism (10) for a horology movement (60), designed to be arranged between an actuator (20) and a receiver (30), including a driving lever (11) designed to be rotated by the actuator (20) along an axis A1, a driven lever (12) which is rotationally mobile along an axis A2 that is not parallel to axis A1, the driven lever (12) being kinematically joined to the driving lever (11) by a rod assembly (13) configured such that rotating the driving lever (11) causes the driven lever (12) to rotate, the latter being designed to cooperate with the receiver (30) when it is rotated.

### CROSS-REFERENCE TO RELATED APPLICATIONS

This application claims priority to European Patent Application No. 24191178.3 filed on Jul. 26, 2024, the entire contents of which are incorporated herein by reference.

### TECHNICAL FIELD OF THE INVENTION

The invention relates to the field of horology, and in particular to horology movements.

More particularly, the invention relates to a horology movement comprising a kinematic chain modulus interposed between a function control device and a device for displaying time indications.

### TECHNOLOGICAL BACKGROUND

Complication watches can have a particularly complex design.

In particular, the horology movement of these watches generally consists of a potentially large number of parts that can be moved by complex kinematics.

In this context, it is necessary to ensure that the kinematics of the moving parts are optimised in order to achieve the lowest possible energy consumption and so that the travel of these parts takes up the most compact volume possible within the horology movement.

### SUMMARY OF THE INVENTION

The invention meets the aforementioned needs and to this end relates to a kinematic chain mechanism for a horology movement, designed to be arranged between an actuator and a receiver.

The kinematic chain mechanism comprises a driving lever designed to be rotated by the actuator along an axis A1, a driven lever which is rotationally mobile along an axis A2 that is not parallel to axis A1, the driven lever being kinematically joined to the driving lever by a rod assembly configured such that rotating the driving lever causes the driven lever to rotate, the latter being designed to cooperate with the receiver when it is rotated.

In particular embodiments, the invention can further comprise one or more of the following features, taken separately or in any technically possible combination.

In particular embodiments, the rod assembly comprises a connecting rod comprising a cap by which it is attached to a driven arm of the driving lever and a small end by which it is attached to a driving arm of the driven lever.

In particular embodiments, the small end of the connecting rod is attached to the driving arm of the driven lever by a connecting link. The connecting link comprises a first end attached so as to be rotationally mobile about the driving arm of the driven lever along an axis A3 and a second end attached to the connecting rod so as to form an articulation allowing rotation along an axis A4 substantially orthogonal to axis A3.

In particular embodiments, the cap of the connecting rod comprises an oblong hole extending lengthwise along a longitudinal axis of the connecting rod, and in which a guide element carried by the driven arm of the driving lever is engaged so that the guide element moves in the oblong hole when the driving lever is rotated.

The invention also relates to a horology movement comprising a kinematic chain mechanism as described above, kinematically interposed between a member for controlling functions of the horology movement designed to be actuated by a user and a device for displaying time indications.

The kinematic chain mechanism is configured so as to act on the time indication display device when the control member is acted upon.

### BRIEF DESCRIPTION OF THE FIGURES

Other features and advantages of the invention will become apparent from the following detailed description, given by way of non-limiting example, with reference to the attached drawings in which:

FIG. 1 shows a perspective view of a kinematic chain mechanism according to a preferred exemplary embodiment of the invention;

FIG. 2 shows a block diagram of the horology movement according to the invention comprising the kinematic chain mechanism in FIG. 1.

It should be noted that the figures are not necessarily drawn to scale for clarity reasons.

### DETAILED DESCRIPTION OF THE INVENTION

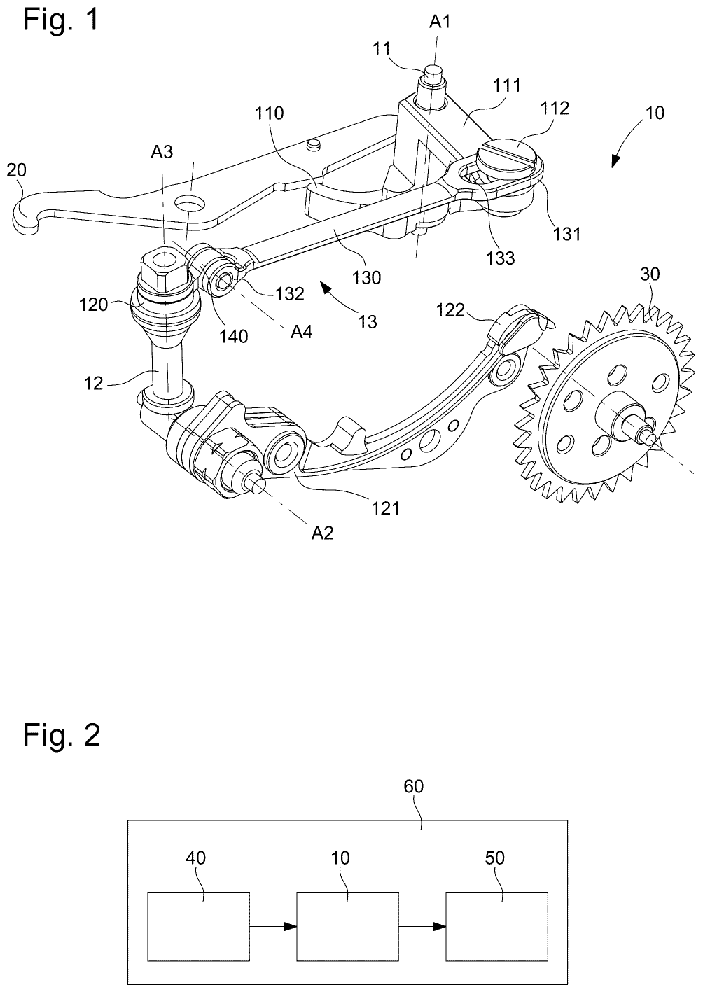

The invention shown in a preferred exemplary embodiment in FIG. 1 relates to a kinematic chain mechanism 10 for a horology movement 60, designed to be arranged between an actuator 20 and a receiver 30.

In one particular application of the invention, the actuator 20 can be joined to a member 40 controlling a function of the horology movement 60 designed to be acted upon by a user, for example a button or a crown. Moreover, the receiver 30 can be joined to a device for displaying time indications 50, for example a device for displaying the date, the day of the week, the month and/or the moon phase, etc.

As a person skilled in the art will know, the kinematic chain concept characterises the ability to transmit movement, i.e., to move kinematically interlinked components. The kinematic chain mechanism 10 is therefore capable of moving the receiver 30 when acted upon by the actuator 20. This aspect of the invention is described in detail below in a preferred exemplary embodiment. The actuator 20 can be in the form of a lever, a rocker arm, an arbor or any other suitable form.

As shown in the figures, the kinematic chain mechanism 10 comprises a driving lever 11 designed to be rotated by the actuator 20 along an axis A1, between a lock position and an active position.

In particular, the driving lever 11 can comprise a driving arm 110 to which the actuator 20 is designed to apply a force when acted upon by a user, so as to rotate said driving lever 11. In the example shown in the figures, the actuator 20 is in the form of a lever.

The kinematic chain mechanism 10 further comprises a driven lever 12 which is rotationally mobile about an axis A2 which is not parallel to axis A1. The driving lever 11 is kinematically joined to the driven lever 12 by a rod assembly 13 so that rotating the driving lever 11 rotates the driven lever 12.

When rotated, the driven lever 12 is designed to cooperate with the receiver 30 to move it.

Here it is understood that the driving lever 11 and the driven lever 12 are designed to both move between a lock position and an active position at the same time.

Advantageously and as is known to those skilled in the art, the driving lever 11 and driven lever 12 are returned to the lock position by one or more return members.

As shown in FIG. 1, in a preferred exemplary embodiment of the invention, the rod assembly 13 comprises a connecting rod 130 with a cap 131 by which it is integral with a driven arm 111 of the driving lever 11 and a small end 132 by which it is integral with a driving arm 120 of the driven lever 12. The connecting rod 130 is connected to the driving lever 11 and to the driven lever 12 so as to have a degree of rotational mobility relative to the latter.

To provide the degrees of mobility required in the preferred exemplary embodiment, the cap of the connecting rod 130 comprises an oblong hole 133 extending lengthwise along a longitudinal axis of the connecting rod 130, and in which a guide element 112 carried by the driven arm 111 of the driving lever 11 is engaged with mechanical clearance. The guide element 112 can be a pin or a screw, as shown in FIG. 1.

Moreover the small end 132 of the connecting rod 130 is attached to the driving arm 120 of the driven lever 12 by a connecting link 140. The connecting link 140 comprises a first end attached so as to be rotationally mobile about the driving arm 120 of the driven lever 12 along an axis A3 and a second end attached to the connecting rod 130 so as to form an articulation allowing rotation along an axis A4 substantially orthogonal to axis A3. In the exemplary embodiment shown in the figures, axis A3 coincides with a longitudinal axis along which the driving arm 120 of the driven lever 12 extends.

Thus, when the driving lever 11 is driven from its lock position to its active position, the guide element 112 describes a curvilinear path centred on axis A1 and applies a force against one of the ends of the oblong hole 133 so as to rotate the driven lever 12 to its active position. During this rotation, the connecting rod 130 pivots relative to the connecting link 140 along axis A4 by an angle which depends on the rotation angle of the driven lever 12. When it transmits the movement of the connecting rod 130 to the driven lever 12, the connecting link 140 also pivots along axis A3 relative to the driven lever 12 due to the curvilinear path of the guide element 112.

In the exemplary embodiment shown in the figures, the driven lever 12 comprises a driven arm 121 designed to cooperate with the receiver 30 when the driven lever 12 reaches its active position. More specifically, as can be seen in the figures, the driven arm 121 can comprise a pawl 122 at one free end, by means of which it rotates the receiver 30, here in the form of a toothed wheel, by one step, and due to which it does not act on the receiver when the driven lever 12 returns to the lock position.

To sum up, in a preferred exemplary embodiment of the invention, in the horology movement 60, the kinematic chain mechanism 10 is kinematically interposed between the member 40 controlling functions of the horology movement 60 and the time indication display device 50, as shown schematically in FIG. 2.

The kinematic chain mechanism 10 is configured so as to act on the time indication display device 50 when the control member 40 is acted upon, as shown by the arrows in FIG. 2.

Advantageously, the present invention makes it possible to transmit a movement from an actuator 20 to a receiver 30 that are mobile in separate planes.

The present invention can be used as a correction mechanism, for example for the date, the day of the week, the month and/or the moon phase, etc.

The driven lever 12 could conceivably be driven by a drive member (not shown in the figures) such as a spiral cam drive, that is rotationally integral with a coaxial drive wheel engaged, for example, by a train of the horology movement, in particular by a twenty-four-hour wheel if the time indication display device 50 is a date. The cam drive is then sequentially rotated by one turn per day. In each of its rotation sequences, it causes the driven lever 12 to move into the active position. The driven lever 12 is forced to return to the lock position by the aforementioned elastic member, when it is not acted upon to move by the cam drive.

Such a cam drive and its interaction with the driven lever are described, for example, in patent applications CH720214 and CH720210. Rotating the driven lever 12 towards its active position, when caused by the cam drive, rotates the connecting rod 130, and moves the oblong hole 133 relative to the guide element 112 without affecting the latter. In this way, the driven arm 111 is not subjected to the action of the cam drive due to the oblong hole 133 in the connecting rod 130.

More generally, it should be noted that the embodiments and uses considered above have been described by way of non-limiting examples, and that other variants are therefore conceivable.

1. A kinematic chain mechanism (10) for a horology movement (60), designed to be arranged between an actuator (20) and a receiver (30), the mechanism comprising: a driving lever (11) designed to be rotated by the actuator (20) along an axis A1; a driven lever (12) which is rotationally mobile along an axis A2 that is not parallel to axis A1, the driven lever (12) being kinematically joined to the driving lever (11) by a rod assembly (13) configured such that rotating the driving lever (11) causes the driven lever (12) to rotate, the driven leaver being designed to cooperate with the receiver (30) when it is rotated.

2. The kinematic chain mechanism (10) according to claim 1, in which the rod assembly (13) comprises a connecting rod (130) comprising a cap (131) by which it is attached to a driven arm (111) of the driving lever (11) and a small end (132) by which it is attached to a driving arm (120) of the driven lever (12).

3. The kinematic chain mechanism (10) according to claim 2, in which the small end (132) of the connecting rod (130) is attached to the driving arm (120) of the driven lever (12) by means of a connecting link (140), said connecting link (140) comprising a first end attached so as to be rotationally mobile about the driving arm (120) of the driven lever (12) along an axis A3 and a second end attached to the connecting rod (130) so as to form an articulation allowing rotation along an axis A4 substantially orthogonal to axis A3.

4. The kinematic chain mechanism (10) according to claim 2, in which the cap (131) of the connecting rod (130) comprises an oblong hole (133) extending lengthwise along a longitudinal axis of the connecting rod (130), and in which a guide element (112) carried by the driven arm (111) of the driving lever (11) is engaged so that the guide element (112) moves in the oblong hole (133) when the driving lever (11) is rotated.

5. A horology movement (60) comprising a kinematic chain mechanism (10) according to claim 4, kinematically interposed between a member (40) for controlling functions of the horology movement (60) designed to be actuated by a user and a device (50) for displaying time indications, the kinematic chain mechanism (10) being configured so as to act on the time indication display device (50) when the control member is acted upon.
